(19) United States
(12) Patent Application Publication
(10) Pub. No.: US 2006/0080511 A1
(43) Pub. Date: Apr. 13, 2006

(54) Enhanced bus transactions for efficient support of a remote cache directory copy

(75) Inventors: Russell D. Hoover, Rochester, MN (US); Jon K. Kriegel, Rochester, MN (US); Eric O. Mejdrich, Rochester, MN (US); Sandra S. Woodward, Rochester, MN (US)

Correspondence Address: Robert R. Williams;IBM Corporation, Dept. 917, 3605 Highway 52 North, Rochester, MN, 55901-7829, US

(73) Assignee: International Business Machines Corporation, Armonk, NY (US)

(21) Appl. No.: 10/961,742

(22) Filed: Oct. 8, 2004

(51) Int. Cl. G06F 12/00

(52) U.S. Cl. 711/141; 711/146

(57) ABSTRACT

Methods and apparatus are provided that may be utilized to maintain a copy of a processor cache directory on a remote device that may access data residing in a cache of the processor. Enhanced bus transactions containing cache coherency information used to maintain the remote cache directory may be automatically generated when the processor allocates or de-allocates cache lines. Rather than query the processor cache directory prior to each memory access to determine if the processor cache contains an updated copy of requested data, the remote device may query its remote copy.

This application is related to commonly owned U.S. patent applications entitled “Direct Access of Cache Lock Set Data Without Backing Memory” Ser. No. ______ (Attorney Docket No. ROC920040048US1), “Efficient Low Latency Coherency Protocol for a Multi-Chip Multiprocessor System” Ser. No. ______ (Attorney Docket No. ROC920040053US1), “Graphics Processor With Snoop Filter” Ser. No. ______ (Attorney Docket No. ROC920040054US1), “Snoop Filter Directory Mechanism in Coherency Shared Memory System” Ser. No. ______ (Attorney Docket No. ROC920040064US1), which are herein incorporated by reference.

### BACKGROUND OF THE INVENTION

1. Field of the Invention

2. Description of the Related Art

In a multiprocessor system, or any type of system that allows more than one device to request and update blocks of shared data concurrently, it is important that some mechanism exists to keep the data coherent (i.e., to ensure that each copy of data accessed by any device is the most current copy). In many such systems, a processor has one or more caches to provide fast access to data (including instructions) stored in relatively slow (by comparison to the cache) external main memory. In an effort to maintain coherency, other devices on the system (e.g., a graphics processing unit-GPU) may include some type of logic to determine if a copy of data from a desired memory location is held in the processor cache by sending commands (snoop requests) to the processor cache directory.

This snoop logic is used to determine if desired data is contained in the processor cache and if it is the most recent copy. If so, in order to work with the latest copy of the data, the device may request ownership of the modified data stored in a processor cache line. In a conventional coherent system, other devices requesting data do not know ahead of time whether the data is in a processor cache. As a result, these devices must snoop every memory location that it wishes to access to make sure that proper data coherency is maintained. In other words, the requesting device must literally interrogate the processor cache for every memory location that it wishes to access, which can be very expensive both in terms of command latency and microprocessor bus bandwidth.

Accordingly, what is needed is an efficient method and system which would minimize the number of commands and latency associated with interfacing with (snooping on) a processor cache.

### SUMMARY OF THE INVENTION

Embodiments of the present invention generally provide methods and apparatus that may be utilized to maintain a copy of a processor cache directory on a remote device that may access data residing in a cache of the processor.

One embodiment provides a method of maintaining coherency of data accessed by a remote device. The method generally includes receiving, by a remote device, a bus transaction containing cache coherency information indicating a change to a cache directory residing on a processor that initiated the bus transaction and updating a cache directory residing on the remote device, based on the cache coherency information, to reflect the change to the cache directory residing on the processor.

Another embodiment provides a method of maintaining coherency of data, wherein the data is cacheable by a processor and accessible by a remote device. The method generally includes maintaining a cache directory on the remote device, the cache directory containing entries indicating the contents and coherency state of corresponding cache lines on the processor as indicated by cache coherency information transmitted to the remote device by the processor. The method also includes receiving, at the remote device, a request to access data associated with a memory location, examining the cache directory residing on the remote device to determine if a copy of the requested data resides in a processor cache in a non-invalid state, and if the cache directory residing on the remote device indicates a copy of the requested data does not reside in a processor cache in a non-invalid state, accessing the requested data from memory without sending a request to the processor.

Another embodiment provides a method of maintaining coherency. The method generally includes allocating a cache line by a processor, resulting in a change to a cache directory residing on the processor and generating a bus transaction to a remote device containing cache coherency information identifying the allocated cache line.

Another embodiment provides a method of maintaining cache coherency. The method generally includes de-allocating a cache line by a processor, resulting in a change to a cache directory residing on the processor and generating a bus transaction to a remote device containing cache coherency information identifying the de-allocated cache line.

Another embodiment provides a device configured to access data stored in memory and cacheable by a processor. The device generally includes one or more processing cores, a cache directory indicative of contents of a cache residing on the processor, and snoop logic configured to receive cache coherency information sent by the processor in bus transactions and update the cache directory based on the cache coherency information, to reflect changes to the contents of the cache residing on the processor.

Another embodiment provides a processor. The processor generally includes one or more processing cores, a cache for storing data accessed from external memory by the processing cores, a cache directory with entries indicating which memory locations are stored in cache lines of the cache and corresponding coherency states thereof, and control logic configured to detect internal bus transactions indicating the allocation and de-allocation of cache lines and, in response, generate external bus transactions to a remote device, each containing cache coherency information indicating cache line that has been allocated or de-allocated.

Another embodiment provides a coherent system generally including a processor and a remote device. The processor has a cache for storing data accessed from external memory, a cache directory with entries indicating which memory locations are stored in cache lines of the cache and corresponding coherency states thereof, and control logic configured to detect internal bus transactions indicating the allocation and de-allocation of cache lines and, in response, generate bus transactions, each containing cache coherency information indicating cache line that has been allocated or de-allocated. The remote device has a remote cache directory indicative of contents of the cache residing on the processor and snoop logic configured to update the remote cache directory, based on cache coherency information contained in the external bus transactions generated by the processor control logic, to reflect allocated and de-allocated cache lines of the processor cache.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system in accordance with embodiments of the present invention;

FIGS. 2A-2D illustrate an exemplary snoop logic configuration and request path diagrams, in accordance with embodiments of the present invention;

FIGS. 3 and 4 are flow diagrams of exemplary operations for maintaining a remote cache directory utilizing enhanced bus transactions when cache lines are allocated and de-allocated, respectively, in accordance with embodiments of the present invention;

FIGS. 5A and 5B illustrate exemplary bits/signals used for enhanced bus transactions for cache line allocation and de-allocation, respectively, in accordance with embodiments of the present invention.

### DETAILED DESCRIPTION OF THE PREFERRED EMBODIMENTS

Embodiments of the present invention generally provide methods and apparatus that may be utilized to maintain a copy of a processor cache directory on a remote device that may access data residing in a cache of the processor. Enhanced bus transactions containing cache coherency information used to maintain the remote cache directory may be automatically generated when the processor allocates or de-allocates cache lines. Rather than query the processor cache directory prior to each memory access to determine if the processor cache contains an updated copy of requested data, the remote device may query its remote copy of the processor cache directory. As a result, the number of commands and latency associated with interfacing with (snooping on) a processor cache may be reduced when compared to conventional coherent systems.

In the following description, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and, unless explicitly present, are not considered elements or limitations of the appended claims.

### An Exemplary System

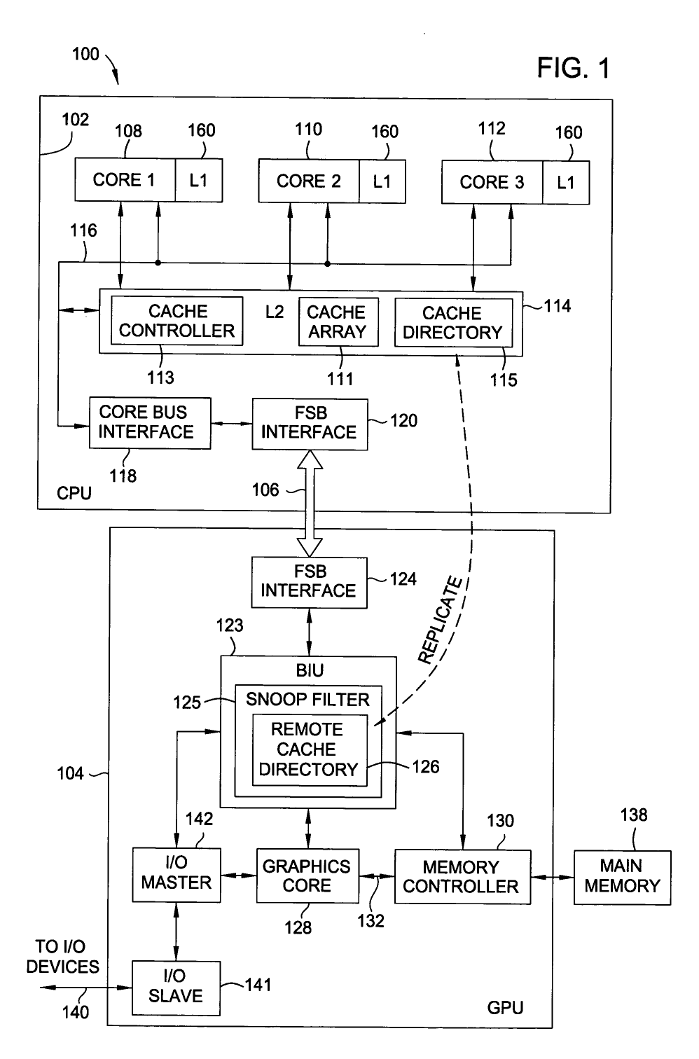

FIG. 1 schematically illustrates an exemplary multi-processor system 100 in which a remote cache directory 126 that mirrors a cache directory 115 of an L2 cache 114 residing on a processor (illustratively, a CPU 102) may be maintained on a remote processing device (illustratively, a GPU 104). FIG. 1 illustrates a graphics system in which main memory 138 is near a graphics processing unit (GPU) and is accessed by a memory controller 130 which, for some embodiments, is integrated with (i.e., located on) the GPU 104. The system 100 is merely one example of a type of system in which embodiments of the present invention may be utilized to maintain coherency of data accessed by multiple devices.

As shown, the system 100 includes a CPU 102 and a GPU 104 that communicate via a front side bus (FSB) 106. The CPU 102 illustratively includes a plurality of processor cores 108, 110, and 112 that perform tasks under the control of software. The processor cores may each include any number of different type function units including, but not limited to arithmetic logic units (ALUs), floating point units (FPUs), and single instruction multiple data (SIMD) units. Examples of CPUs utilizing multiple processor cores include the Power PC line of CPUs, available from IBM.

Each individual core may have a corresponding L1 cache 160 and may communicate over a common bus 116 that connects to a core bus interface 118. For some embodiments, the individual cores may share an L2 (secondary) cache memory 114. The core bus interface 118 communicates with the L2 cache memory 114, and carries data transferred into and out of the CPU 102 via the FSB 106, through a front-side bus interface 120.

The GPU 104 also includes a front-side bus interface 124 that connects to the FSB 106 and that is used to pass information between the GPU 104 and the CPU 102. The GPU 104 is a high-performance video processing system that processes large amounts of data at very high speed using sophisticated data structures and processing techniques. To do so, the GPU 104 includes at least one graphics core 128 that processes data obtained from the CPU 102 or from main memory 138 via the memory controller 130. The memory controller 130 connects to the graphics front-side bus interface 124 via a bus interface unit (BIU) 123. Data passes between the graphics core 128 and the memory controller 130 over a wide parallel bus 132. The main memory 138 typically stores operating routines, application programs, and corresponding data that may be accessed by the CPU 102 and GPU 104.

For some embodiments, the GPU 104 may also include an I/O port 140 that connects to an I/O driver 142. The I/O driver 142 passes data to and from any number of external devices, such as a mouse, video joy stick, computer board, and display, via an I/O slave device 141. The I/O driver 142 properly formats data and passes data to and from the graphic front-side bus interface 124. That data is then passed to or from the CPU 102 or is used in the GPU 104, possibly being stored in the main memory 138 by way of the memory controller 130. As illustrated, the graphics cores 128, memory controller 130, and I/O driver 142 may all communicate with the BIU 123 that provides access to the FSB via the GPU's FSB interface 124.

As previously described, in conventional multi-processor systems such as system 100 in which one or more remote devices request access to data for memory locations that are cached by a central processor, the remote devices often utilize some type of logic to monitor (snoop) the contents of the processor cache. Typically, this snoop logic interrogates the processor cache for every memory location the remote device wishes to access. As a result, conventional cache snooping may result in substantial latency and consume a significant amount of processor bus bandwidth.

### Remote Snoop Filter

In an effort to reduce such latency and increase bus bandwidth, embodiments of the present invention may utilize a snoop filter 125 that maintains a remote cache directory 126 which, in effect, attempts to mirror the cache directory 114 on the CPU 102. Accordingly, when a remote device attempts to access data in a memory location, the snoop filter 125 may check the remote cache directory 126 to determine if a modified copy of the data is cached at the CPU 102 without having to send bus commands to the CPU 102. As a result, the snoop filter 125 may “filter out” requests to access data that is not cached in the CPU 102 and route those requests directly to memory 138, via the memory controller 130, thus reducing latency and increasing bus bandwidth. As will be described in greater detail below, the snoop filter 125 may operate in concert with a cache controller 113 which may generate enhanced bus transactions containing cache coherency information used by the snoop filter 125 to update the remote cache directory 126 to reflect changes to the CPU cache directory 115.

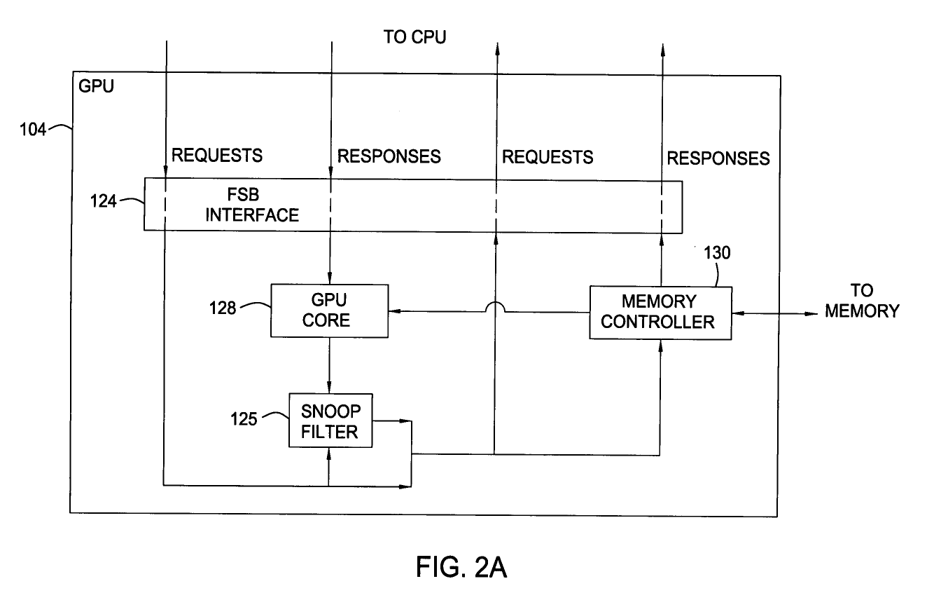

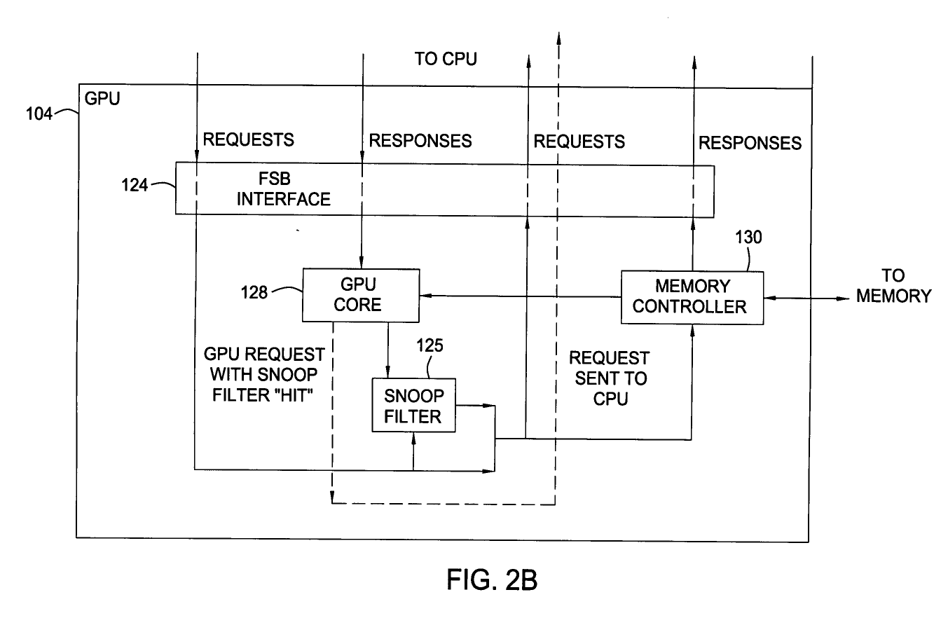

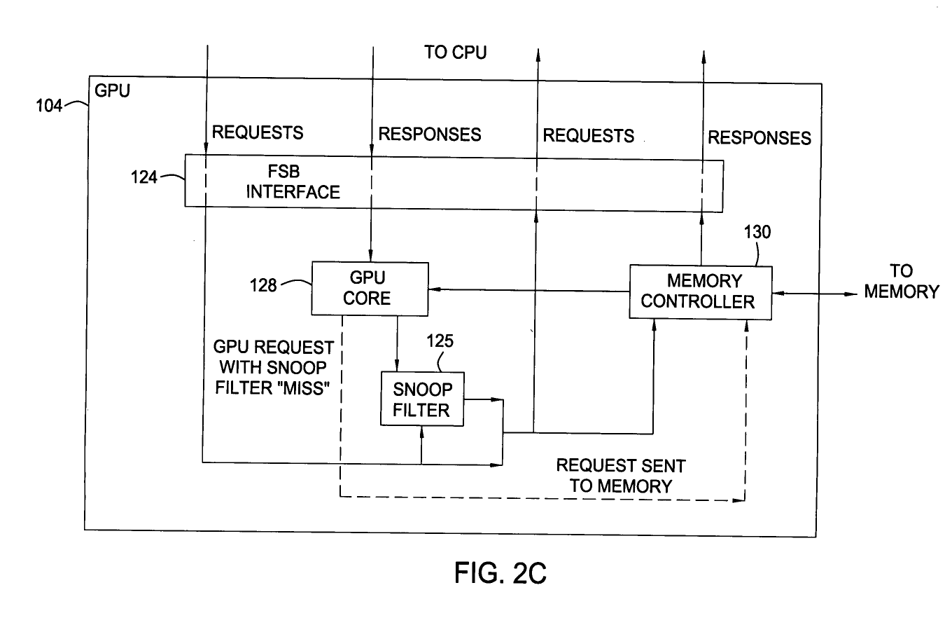

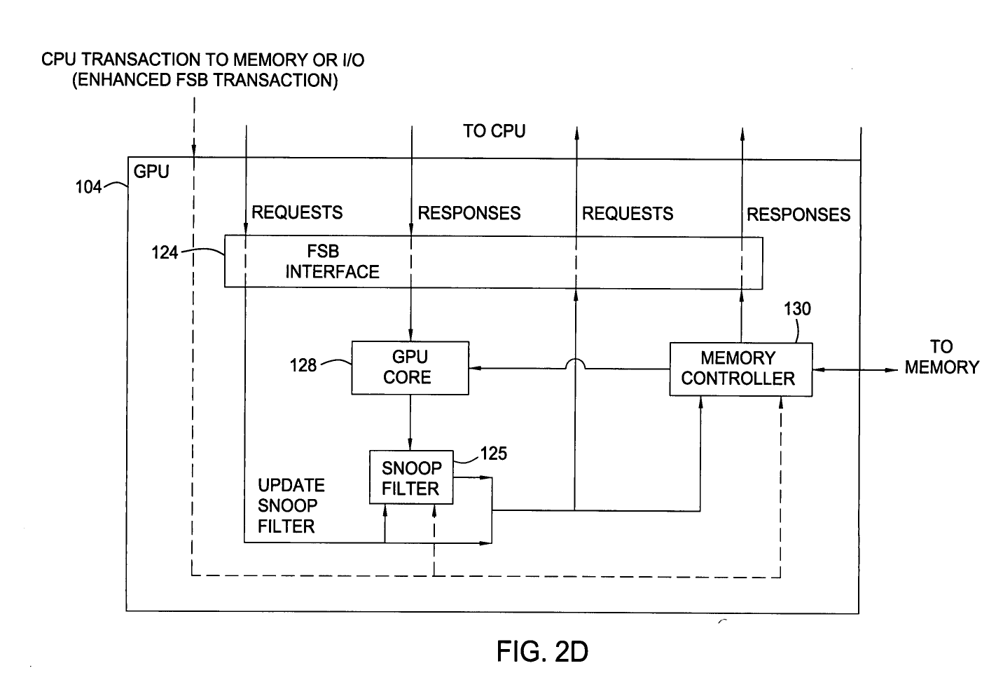

Operation of the snoop filter 125 in routing data access requests may be described with reference to FIGS. 2A-2D which illustrate an exemplary snoop filter configuration and request path diagrams, in accordance with embodiments of the present invention. To facilitate discussion, the functionality of the snoop filter 125 with respect to routing memory access requests from a GPU core 128 to the CPU 102 and/or memory controller 130 are described. However, it should be understood the snoop filter 125 may perform similar operations to route I/O requests from a I/O master device 142 to the CPU 102 and/or an I/O slave device 141.

As illustrated in FIG. 2A, the snoop filter 125 may receive, from the GPU core 128, requests targeting a memory location. Depending on whether the targeted memory location is cached in the CPU 102, as determined by examining the remote cache directory 126, the snoop filter 125 may route the request directly to memory (via memory controller 130) or send a bus command up to the CPU 102.

For example, as illustrated in FIG. 2B, if examination of the cache directory 126 results in a hit with the requested memory location, indicating the requested location is cached in the CPU 102, a bus command may be sent to the CPU 102 to invalidate it's copy or cast out/evict its copy (if modified). The requested data may then be transferred directly to the GPU core 128 from the CPU 102 or written out to memory by the CPU 102 and subsequently transferred to the GPU core 128 via the memory controller 130. On the other hand, as illustrated in FIG. 2C, if examination of the cache directory 126 results in a miss with the requested memory location, indicating the requested location is not cached in the CPU 102, the requested memory location may be routed directly to memory, via the memory controller 130. In summary, the snoop filter 125 acts to properly route memory access requests based on the contents of the CPU cache, as indicated by the remote cache directory 126.

### Enhanced Bus Transactions

As illustrated in FIG. 2D, for some embodiments, in an effort to ensure the remote cache directory 126 mirrors the CPU cache directory 115, and accurately reflects the contents and coherency state of the contents of the CPU cache 114, enhanced bus transactions may be utilized as a mechanism to transfer cache coherency information from the CPU 102 to the GPU 104. As illustrated, these enhanced bus transactions may be automatically initiated by snoop support logic in the cache controller 113 upon detecting transactions that result in the allocation or de-allocation of cache lines in the L2 cache 114.

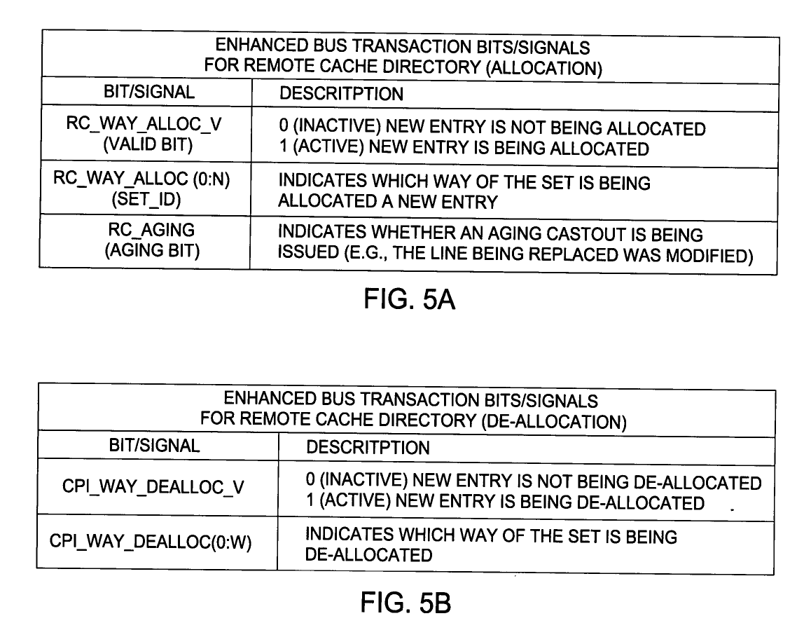

Depending on the particular bus interface, the cache coherency information may be transmitted as a set of dedicated bus signals, or as control bits in a data packet (as described in greater detail below with reference to FIG. 5). In any case, the cache coherency information incorporated in these enhanced bus transactions may include any type of information that may be used by the snoop filter 125 to update the remote cache directory 126 to reflect changes to the CPU cache directory 115 resulting from cache line allocating/deallocating. This information may include an indication that an allocation or de-allocation transaction occurred and, if so, a particular cache line in an associative set that is being replaced (e.g., the way within the set), as well as if an aging castout was generated (modified data is being written back to memory).

These bus transactions may be considered enhanced because, in some cases, this additional coherency information may be added to information already included in a bus transaction occurring naturally. For example, a cache line allocation may naturally precede a bus transaction to read requested data to fill the allocated cache line. Similarly, a cache line de-allocation may naturally occur as a result of a write-with-kill command resulting in a bus transaction to castout modified data. While such requests might typically include an address of the requested data, which readily identifies an associative set of cache lines assigned to that address, without the set_id the snoop filter 125 would not know which way within the set was being allocated (and which way contains a cache line being evicted or castout).

### Maintaining the Remote Cache Directory

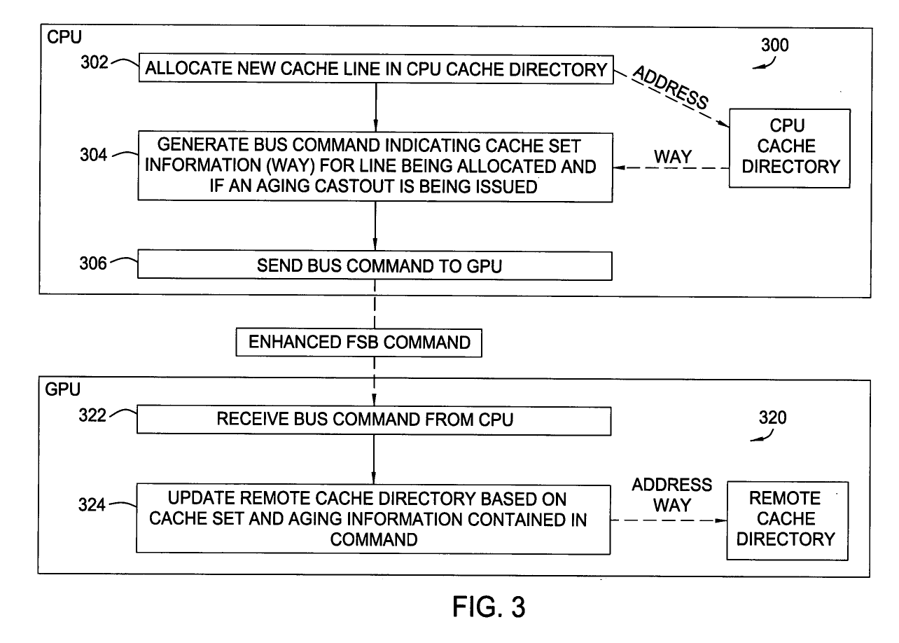

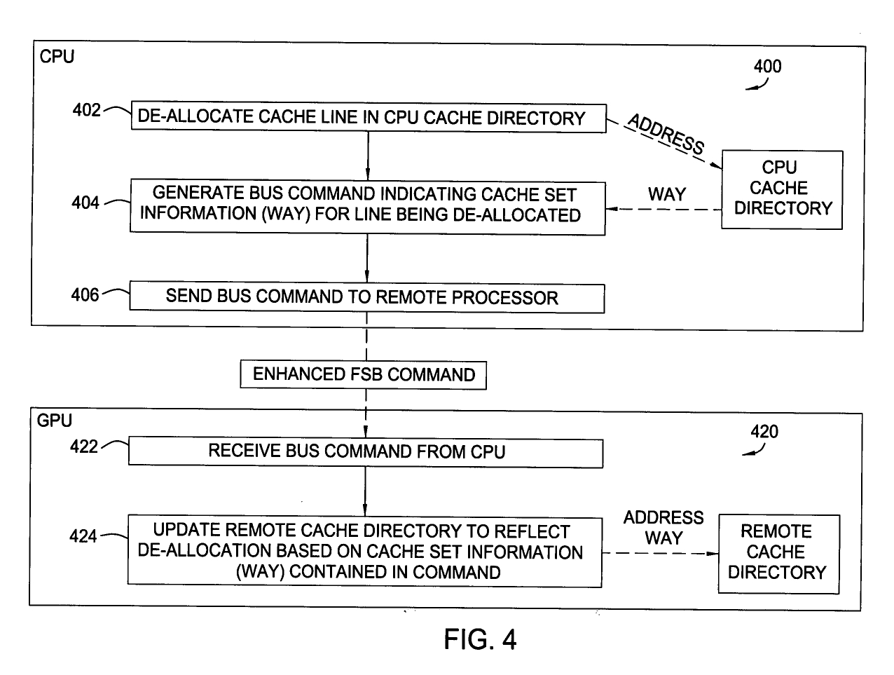

FIGS. 3 and 4 are flow diagrams of exemplary operations for maintaining a remote cache directory utilizing enhanced bus transactions when cache lines are allocated and de-allocated, respectively, in accordance with embodiments of the present invention. FIG. 3 illustrates exemplary operations 300 and 320 performed by the CPU 102 and GPU 104, respectively, to maintain a remote cache directory 126 on the GPU 104 that mirrors the CPU cache directory 115 as new cache lines are allocated.

For example, the operations 300 may be performed by the cache controller 113 in response to receiving a request to read, read with intent to modify (or Dclaim) that results in a cache miss with the L2 cache 114 (the targeted memory location is not in the L2 cache). At step 302, a new cache line is allocated in the CPU cache directory. At step 304, a bus command indicating cache set information (way) for the cache line being allocated and if an aging castout is being issued (i.e., the cache line being replaced is modified). At step 306, the bus command is sent to the GPU 104.

At step 322, the GPU 104 receives the bus command from the CPU 102. At step 324, the remote cache directory 126 is updated based on the cache set information and aging indication contained in the bus command. In other words, the GPU 104 may parse the enhanced coherency information contained in the bus command and update the remote cache directory 126 to be consistent with the CPU cache directory 115.

As previously described, the enhanced coherency information corresponding to the cache line allocation transmitted to the GPU 104 may be in the form of bus signals or bits in a data packet. The table shown in FIG. 5A lists exemplary bits/signals that may be used to carry enhanced coherency information. To simplify the following description, it will be assumed that this coherency information is in the form of bits (e.g., contained in a data packet sent as part of the bus transaction), although it should be understood that dedicated “wired” bus signals may be utilized in a similar manner.

As illustrated in FIG. 5A, for some embodiments, the coherency information may include a valid bit (rc_way_alloc_v) indicating whether or not a new entry is being allocated, set_id bits (rc_way_alloc[0:N]) indicating the way of the cache line being allocated, and an aging bit (rc_aging) indicating whether an aging castout (e.g., of a modified cache line) is being issued. If the valid bit is inactive, the remaining bits may be ignored, since a new entry is not being allocated (e.g., a cache line for a targeted memory location already exists in L2 cache). In other words, the coherency information may be sent with each such transaction, even when a new line is not being allocated, to avoid having separate transactions for transferring coherency information. In such embodiments, the GPU 104 may quickly check the valid bit to determine if a new cache line is being allocated.

If the valid bit is set, the set_id bits may be examined to determine which cache line of an associate set is being allocated. For example, for a 4-way associate cache (N=1), a two bit set_id may indicate one of 4 available cache lines, for an 8-way associative cache (N=2), a 3-bit set_id may indicate one of 8 available cache lines, and so on. As an alternative, individual bits (or signals) for each of the ways of the set may be used which, in some cases, may provide improved timing.

The aging bit set indicates an aging castout is being issued, for example, since the coherency state of the aging L2 cache line is modified (M). The aging bit cleared indicates that the entry being replaced is not being castout, for example, because the aging L2 entry was invalid (I), shared (S), or exclusive (E), and can be overwritten with this new allocation.

It should be noted that, in some cases, the remote cache directory 126 may indicate more valid cache lines are in the L2 cache 114 than are indicated by the CPU cache directory 115 (e.g., the valid cache lines indicated by the remote cache directory may represent a superset of the actual valid cache lines). This is because cache lines in the L2 cache 114 may transition from Exclusive (E) or Shared (S) to Invalid (I) without any corresponding bus operations to signal these transitions. While this may result in occasional additional requests sent from the GPU 104 to the CPU 102 (the CPU 102 can respond that its copy is invalid), it is also a safe approach aimed at ensuring the CPU is always checked if the remote cache directory 126 indicates requested data is cached.

When L2 cache lines are de-allocated (e.g., due to a write with kill), enhanced bus transactions containing coherency information related to the de-allocation may also be generated. This coherency information may include an indication an entry is being de-allocated and the set_id (way) indicating which cache line within an associative set being de-allocated. This information may be generated by “push snoop logic” in the L2 cache 114 and carried in a set of control bits/signals, as with the previously described coherency information transmitted upon cache line allocation. This coherency information will be used by the GPU snoop filter 125 to correctly invalidate the corresponding entry in the (L2 superset) remote cache directory 126.

FIG. 4 illustrates exemplary operations 400 and 420 performed by the CPU 102 and GPU 104, respectively, to maintain a remote cache directory 126 on the GPU 104 that mirrors the CPU cache directory 115 as cache lines are de-allocated. For example, the operations 400 may be performed by the cache controller 113 in response to receiving a “write-with-kill” request to write the (modified) contents of a cache line out to memory.

The operations 400 begin, at step 402, by de-allocating a cache line in the CPU cache directory 115. At step 404, a bus command indicating cache set information (way) for the cache line being de-allocated is generated. At step 406, the bus command is sent to the GPU 104. At step 422, the GPU 104 receives the bus command and, at step 424, updates the remote cache directory 126 to reflect the de-allocation based on the cache set information contained in the command. In other words, the snoop filter 125 may invalidate, in the remote cache directory 126, the entry indicated in the bus command. As illustrated in FIG. 5B, the coherency information related to the de-allocation may be carried in similar bits/signals (valid and set_id) to those related to allocation shown in FIG. 5A. As the de-allocation assumes a castout, there may be no need for an aging bit.

### Maintaining the Remote Cache Directory

By maintaining a copy of a processor cache directory on a remote device that may access data residing in a cache of the processor, the remote device may be able to determine if requested memory locations are contained in a central processor cache without sending bus commands to query the processor cache. By receiving cache coherency information in bus transactions automatically generated by the processor when allocating and de-allocating cache lines, the remote device may be able to modify its remote cache directory to reflect changes to the processor cache directory. As a result, the number of bus commands conventionally associated with interfacing with (snooping on) a processor cache may be reduced, thus increasing bus bandwidth and reducing latency.

While the foregoing is directed to embodiments of the present invention, other and further embodiments of the invention may be devised without departing from the basic scope thereof, and the scope thereof is determined by the claims that follow.

What is claimed is:

1. A method of maintaining coherency of data accessed by a remote device, comprising:
receiving, by a remote device, a bus transaction containing cache coherency information indicating a change to a cache directory residing on a processor that initiated the bus transaction; and
updating a cache directory residing on the remote device, based on the cache coherency information, to reflect the change to the cache directory residing on the processor.

2. The method of claim 1, wherein the updating the cache directory residing on the remote device comprises updating an entry corresponding to a cache line indicated by the cache coherency information.

3. The method of claim 2, wherein the cache coherency information comprises a set of bits indicative of a cache line within an associative set of cache lines.

4. The method of claim 3, further comprising determining the associative set of cache lines based on an address provided in the bus transaction.

5. The method of claim 2, wherein the cache coherency information comprises an indication of whether data stored in a cache line being replaced is to be written out to memory.

6. The method of claim 1, wherein the cache coherency information comprises a bit indicating at least one of: whether a new cache line is being allocated or whether a cache line is being de-allocated.

7. A method of maintaining coherency of data, wherein the data is cacheable by a processor and accessible by a remote device, comprising:
maintaining a cache directory on the remote device, the cache directory containing entries indicating the contents and coherency state of corresponding cache lines on the processor as indicated by cache coherency information transmitted to the remote device by the processor;
receiving, at the remote device, a request to access data associated with a memory location;
examining the cache directory residing on the remote device to determine if a copy of the requested data resides in a processor cache in a non-invalid state; and
it the cache directory residing on the remote device indicates a copy of the requested data does not reside in a processor cache in a non-invalid state, accessing the requested data from memory without sending a request to the processor.

8. The method of claim 7, further comprising, if the cache directory residing on the remote device indicates a copy of the requested data does reside in a processor cache in a non-invalid state, sending a bus command to the processor to at least one of: invalidate or cast out its copy of the requested data.

9. The method of claim 7, further comprising:
receiving, by the remote device, a bus transaction initiated by the processor containing cache coherency information indicating a change to a cache directory residing on the processor; and
updating the cache directory residing on the remote device, based on the cache coherency information, to reflect the change to the cache directory residing on the processor.

10. A method of maintaining coherency, comprising:
allocating a cache line by a processor, resulting in a change to a cache directory residing on the processor; and
generating a bus transaction to a remote device containing cache coherency information identifying the allocated cache line.

11. The method of claim 10, wherein generating the bus transaction comprises creating a data packet with one or more bits containing the cache coherency information.

12. The method of claim 10, wherein the bus transaction corresponds to a read of data to be stored in the allocated cache line.

13. A method of maintaining cache coherency, comprising:
de-allocating a cache line by a processor, resulting in a change to a cache directory residing on the processor; and
generating a bus transaction to a remote device containing cache coherency information identifying the de-allocated cache line.

14. The method of claim 10, wherein generating the bus transaction comprises creating a data packet with one or more bits containing the cache coherency information.

15. The method of claim 14, wherein the bus transaction corresponds to a cast out of data previously stored in the de-allocated cache line.

16. A device configured to access data stored in memory and cacheable by a processor, comprising:
one or more processing cores;
a cache directory indicative of contents of a cache residing on the processor; and
snoop logic configured to receive cache coherency information sent by the processor in bus transactions and update the cache directory based on the cache coherency information, to reflect changes to the contents of the cache residing on the processor.

17. The device of claim 16, wherein the snoop logic is configured to receive cache coherency information indicating a cache line that has been de-allocated by the processor and invalidate a corresponding entry in the cache directory.

18. The device of claim 16, wherein the snoop logic is further configured to:
receive, from the processing core, a request to access data associated with a memory location;
examine the cache directory to determine if a copy of the requested data resides in a processor cache in a non-invalid state; and
if the cache directory residing on the remote device indicates a copy of the requested data does not reside in a processor cache in a non-invalid state, route the request to a memory controller to access the requested data from memory without sending a request to the processor.

19. A processor, comprising:
one or more processing cores;
a cache for storing data accessed from external memory by the processing cores;
a cache directory with entries indicating which memory locations are stored in cache lines of the cache and corresponding coherency states thereof; and
control logic configured to detect internal bus transactions indicating the allocation and de-allocation of cache lines and, in response, generate external bus transactions to a remote device, each containing cache coherency information indicating cache line that has been allocated or de-allocated.

20. A coherent system, comprising:
a processor having a cache for storing data accessed from external memory, a cache directory with entries indicating which memory locations are stored in cache lines of the cache and corresponding coherency states thereof, and control logic configured to detect internal bus transactions indicating the allocation and de-allocation of cache lines and, in response, generate bus transactions, each containing cache coherency information indicating cache line that has been allocated or de-allocated; and
a remote device having a remote cache directory indicative of contents of the cache residing on the processor and snoop logic configured to update the remote cache directory, based on cache coherency information contained in the external bus transactions generated by the processor control logic, to reflect allocated and de-allocated cache lines of the processor cache.

21. The system of claim 20, wherein the remote device is a graphics processing unit (GPU) including one or more graphics processing cores.

22. The system of claim 21, wherein the snoop logic is configured to:
receive a memory access request issued by a graphics processing core;
determine if a copy of data targeted by the request is contained in the processor cache in a non-invalid state by examining the remote cache directory; and
if not, route the request to external memory without sending a request to the processor.

23. The system of claim 22, wherein the snoop logic is configured to route request to external memory via a memory controller integrated with the remote device.
